(19) United States
(12) Patent Application Publication
(10) Pub. No.: US 2019/0248429 A1
(43) Pub. Date: Aug. 15, 2019

(54) Device For Manoeuvring An Aerodynamic Flap

(71) Applicant: Compagnie Plastic Omnium, Lyon (FR)

(72) Inventors: Stéphane Parra, Vaulx-En-Velin (FR); Philippe Gilotte, Benonces (FR)

(21) Appl. No.: 16/065,541

(22) PCT Filed: Dec. 12, 2016
(86) PCT No.: PCT/FR2016/053325

§ 371 Date: Jun. 22, 2018

(30) Foreign Application Priority Data
Dec. 22, 2015 (FR) 1563021

(51) Int. Cl. B62D 35/00; B62D 37/02

(52) U.S. Cl. CPC B62D 35/005; B62D 37/02; B62D 35/007

(57) ABSTRACT

A device for manoeuvring an aerodynamic flap arranged on a motor vehicle, characterised in that it includes mechanical ways for shifting the flap from a retracted position to a deployed position, successively performing a movement extending the flap while keeping the plane of the flap parallel to the direction of an air stream flowing around the flap when the vehicle is moving, such that the aerodynamic pressure exerted on the flap is substantially zero, and then a movement pivoting the flap about a pivot axis located in a plane of the flap and passing substantially through a centre of aerodynamic thrust of the flap, such that the torque applied to the pivot axis and resulting from the aerodynamic forces is substantially zero. The shift from a deployed position to a retracted position is carried out by performing said movements in reverse order.

### BACKGROUND OF THE INVENTION

The invention relates to a mechanical maneuvering device for deploying or retracting an aerodynamic flap which is used, for example, in motor vehicles in order to modify the air intake conditions in an engine ventilation duct.

This flap occupies a retracted position, in which the plane of the flap is integrated in a housing formed in the plane of the bodywork with which the flap is coincident, and a deployed position, in which the flap frustrates the flow of the air in such a way as to divert part of the flow and obtain an aerodynamic effect by which it is possible to reduce the aerodynamic losses downstream from the flap.

Optionally, the flap can also serve to close the ventilation duct.

For example, a flap of this type can be arranged under the front bumper at the entry to the lower engine ventilation mouth.

Other uses employing a movable aerodynamic flap are likewise conceivable. This is the case, for example, of an air deflector arranged on the roof at the roof opening in order to improve the acoustic comfort conditions when the roof opening is open, or of the flap equipping the tailgate, or the wings, in order to modify the aerodynamic downforces of the vehicle when the latter is traveling at high speed.

### Description of the Prior Art

The maneuvering mechanism of the flap customarily comprises a motor coupled to a geared motor acting on a rotation axle situated on one of the side edges of the flap, and about which the flap pivots or tilts in order to pass from one position to another.

However, it has been found that this type of mechanism has a number of disadvantages.

For example, in order to perform the maneuver, it is necessary to provide a motor of relatively high power in order to generate an opening torque capable of withstanding the torque generated by the aerodynamic pressure exerted on the flap when the vehicle is traveling at high speed.

The object of the invention is to limit this disadvantage.

### SUMMARY OF THE INVENTION

The object of the proposed maneuvering device is to drive in motion an aerodynamic flap arranged on a motor vehicle. This maneuvering device is characterized in that it comprises mechanical means for changing the flap from a retracted position to a deployed position, by performing movements in a given order:
extending the flap while keeping the plane of the flap parallel to the direction of an air flow circulating around the flap when the vehicle is moving, such that the aerodynamic pressure exerted on the flap is substantially zero, then
pivoting the flap about a pivot axis passing substantially through a center of aerodynamic thrust of the flap, such that the torque applied to the pivot axis and resulting from the aerodynamic forces exerted on the flap is substantially zero,
and, conversely, from a deployed position to a retracted position by performing said movements in reverse order.

This mode of deployment makes it possible to reduce the motor torque required for the extending and pivoting movements alone.

It goes without saying that, when the angle of incidence of the flap increases as the latter tilts about its pivot axis, the aerodynamic force exerted on the flap by the air also increases. Moreover, special means have to be provided in order to keep the flap in the deployed position once this movement has ended.

As will be seen below, these means can usefully be separate from the motor element driving the mechanical device, such that the motor is powered up only to ensure the changes of position, and it is no longer necessary to keep the motor powered up when the aerodynamic flap is in the deployed position.

Although many mechanical arrangements are conceivable for achieving the deployment and retraction movements according to the invention, the maneuvering device is based on original mechanical means which comprise, individually or in combination, the following features:
the mechanical means comprise a secondary rotation axis which is parallel to the pivot axis and about which are articulated a first rocker, connected to the aerodynamic flap by a first link rod and of which the change of position brings about the extending or retracting movement of the flap, and a second rocker, which is connected to the flap by a second connecting rod and of which the change of position brings about the pivoting movement of the flap.
the first and second link rod are attached, by first and second articulations respectively arranged at both ends of each of the link rods and whose axes are parallel to the pivot axis, to a face of the flap on the one hand and to said rockers on the other, and the projections, on a plane perpendicular to the pivot axis, of the axes of said articulations are arranged substantially at the four corners of a deformable parallelogram.
the first link rod is connected to the flap by its first articulation, whose axis is coincident with the pivot axis, and to the first rocker by its second articulation, whose axis is coincident with the secondary rotation axis, such that the first link rod pivots about the secondary rotation axis when the first rocker changes position.
the second link rod is connected to the second rocker by its second articulation arranged radially at a given distance d from the secondary rotation axis, and to the flap by its first articulation arranged at the same distance d from the pivot axis of the flap.
the positions of the link rods are set up such that a plane through the secondary axis and the axis of articulation of the second link rod on the second rocker is substantially parallel to the plane of the flap.
the mechanical means comprise a drive wheel driven in rotation about a main axis parallel to the pivot axis, at least one face of the disk formed by the drive wheel having a pin for rotationally moving the first and second rockers from one position to another and vice versa.
each rocker comprises a radial slot in which circulates a pin for causing said rocker to pivot from one position to another about the secondary rotation axis.
the drive wheel comprises at least one circular blocking disk having the same rotation axis as the drive wheel and arranged in elevation on each of the faces of the disk formed by the drive wheel having a pin, of which the radius is less than the distance to the main axis of said pin, and placed opposite at least one rocker.
the drive wheel comprises two blocking disks each arranged on one of the faces of the disk formed by the drive wheel, each of these faces having a pin, and the rockers are arranged in line with each of the blocking disks on either side of the disk formed by the drive wheel.
each rocker comprises two semi-circular cutouts respectively defining a first and a second position of the rocker, arranged on either side of the radial slot, each semi-circular cutout having a radius equal to the radius of the blocking disk opposite which said rocker is placed.
when a rocker is placed in a position, the center of a semi-circular cutout is arranged on the main axis, such that said rocker is locked in rotation by the blocking disk opposite which it is placed.
when the first and second rocker are each placed in a given position, the torque applied on the main rotation axis and resulting from forces exerted on the flap is zero.
each blocking disk has a recess arranged radially in line with the pin, so as to permit the pivoting of the rocker when the latter changes position.
the flap is in the retracted position when the first rocker is in a first position.
the flap is in the extended position when the first rocker is in a second position.
the flap is parallel to the air flow circulating on the bodywork element supporting the flap when the vehicle is moving, when the second rocker is in a first position.
the flap is in the pivoted position when the second rocker is in a second position.
when the drive wheel travels over an angular path of less than 360°, the respective arrangements of the rockers and the pins are adjusted angularly about the main axis such that the change of position of the first rocker takes place when the second rocker is arranged in the first position, and such that the change of position of the second rocker takes place when the first rocker is arranged in the second position.
the drive wheel is rotated under the action of a motor coupled to a geared motor.

### BRIEF DESCRIPTION OF THE DRAWINGS

The invention will be better understood from the attached figures, which are provided as non-limiting examples and in which:

FIG. 1 is a simplified perspective view of the mechanical means used,

FIGS. 2, 3 and 4 permit visualization of the operation of the mechanical means during the extending movement of the flap,

FIGS. 5, 6, 7 and 8 permit visualization of the operation of the mechanical means during the pivoting movement of the flap,

FIG. 9 is a simplified perspective view of a maneuvering device mounted on the front bumper of a motor vehicle.

### DETAILED DESCRIPTION OF THE INVENTION

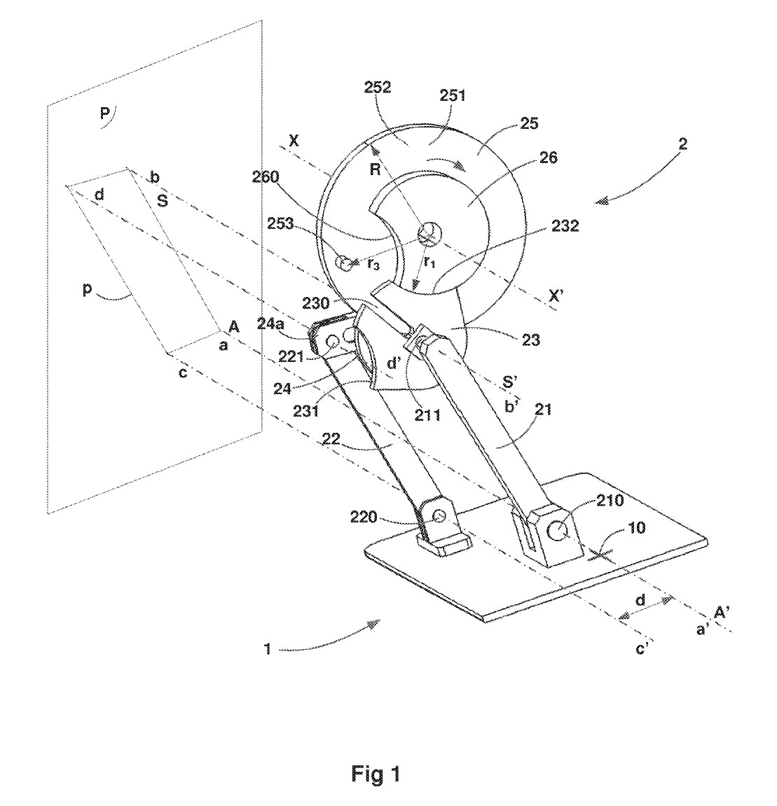

The maneuvering device illustrated in FIG. 1 comprises an aerodynamic flap 1 connected by a first and second link rod 21 and 22, respectively, to mechanical means designed to drive the extending and pivoting movements of the flap.

The maneuvering device serving to support the present description concerns a flap situated at the front of the vehicle in the lower part of the bumper. This type of aerodynamic flap passes alternately from a retracted position to a deployed position in which it directs the air flow in order to improve the aerodynamics of the vehicle and to reduce the downstream loss of charge in the underframe. Being placed close to the ground, special attention is also paid to the speed of retraction in order to prevent the flap from being damaged by obstacles detected by a radar placed at the front of the vehicle.

The flap comprises a center of aerodynamic thrust 10 whose location is determined theoretically by the shape and the angle of incidence of the flap and by the speed of the air flow circulating around the flap when the vehicle is moving. Although this theoretical position is variable, it is nonetheless possible to determine an average position experimentally. This position is close to the geometric center of the flap when the latter has, for example, a planar shape.

When the angle of incidence of the flap changes, the torque deriving from the resultant of the aerodynamic forces generated by the flow of air applied about a pivot axis AA′, situated substantially in the plane of the flap and passing substantially through the center of aerodynamic thrust 10, is therefore close to zero.

The first link rod 21 is connected to the flap by a first articulation 210 of axis aa′. Provision is made that the axis aa′ is substantially coincident with the pivot axis AA′ passing through the center of thrust 10.

The first link rod 21 is attached by a second articulation 211 to a first rocker 23. The first link rod 21 is locked in rotation relative to the first rocker 23 such that the first link rod 21 and the first rocker 23 can optionally form a single component freely articulated in rotation about the axis SS′.

The first rocker 23 pivots about a secondary rotation axis SS′ coincident with the rotation axis bb′ of the second articulation 211 of the first link rod 21. The rotational movement of the first rocker 23 about the axis SS′ thus drives the rotational movement of the first link rod 21 about this same axis.

The axis SS′ is parallel to the pivot axis AA′. This axis is fixed in the reference frame formed by the vehicle.

The flap 1 is likewise connected to the mechanical means by a second link rod 22. The second link rod 22 is connected to the flap by a first articulation 220 of axis cc′ which is parallel to the pivot axis AA′ and spaced apart from this axis by a length d. The other end of the second link rod is connected by a second articulation 221, of axis dd′ parallel to the pivot axis AA′, to a second rocker 24, 24a. The second rocker is articulated freely in rotation about the secondary axis SS′. The axis dd′ is spaced apart from the secondary rotation axis SS′ by a distance d.

It will be noted here that the plane of the flap can be likened to the plane passing through the axes AA′ and cc′. Moreover, in order to achieve the best results, the space taken up by the articulations 210 and 220 will be reduced as much as possible, such that the distance between the plane passing through the axes AA′ and cc′, likened to the plane of the flap, and a plane parallel to this plane and passing through the center of aerodynamic thrust and substantially corresponding to the mean plane of the flap, is as small as possible. When the flap has a more or less curved shape in order to adapt to the profile of the bodywork, this mean plane can be defined experimentally so as to arrange the axes AA′ and cc′ accordingly.

The second rocker 24 can have a transfer arm 24a, which is fixed to the second rocker 24, and at the end of which is positioned the articulation 221 with the second link rod 22. The transfer arm 24a is blocked in rotation relative the second rocker 24. The second rocker 24 and the transfer arm 24a can likewise form a single component.

Provision is than made that the distances between the axes of the first and second articulation of each of the link rods are substantially identical, such that the projection onto an imaginary plane P, perpendicular to the pivot axis AA′, of the axes SS′ (aa′), bb′, cc′ and dd′ forms a deformable parallelogram p.

The plane of the flap is thus substantially parallel to a plane passing through the secondary axis SS′ and through the axis dd′.

As will be explained in more detail below, under the action of the first rocker 23, the rotation of the first link rod about the axis SS′ controls the extending movement of the flap. By keeping the second rocker in a fixed position about the secondary rotation axis SS′, the plane of the flap occupies, during the extension movement, successive positions which are all mutually parallel. This imaginary plane may usefully be adjusted in order to be parallel to the direction of the air flow circulating on the bodywork element supporting the flap when the vehicle is moving, such that the aerodynamic pressure exerted on the flap during the movement of extension is substantially zero. The driving force is reduced to only the forces needed generate the rotational movement of the first rocker.

Once the flap is extended, and by keeping the position of the first rocker fixed, the rotation of the second rocker 24 about the axis SS′ causes the pivoting movement of the flap about the pivot axis AA′. As has been mentioned above, this axis AA′ passes substantially through the center of aerodynamic thrust 10, such that the necessary torque transmitted by the second link rod 22 in order to pivot the flap about the axis AA′ is low.

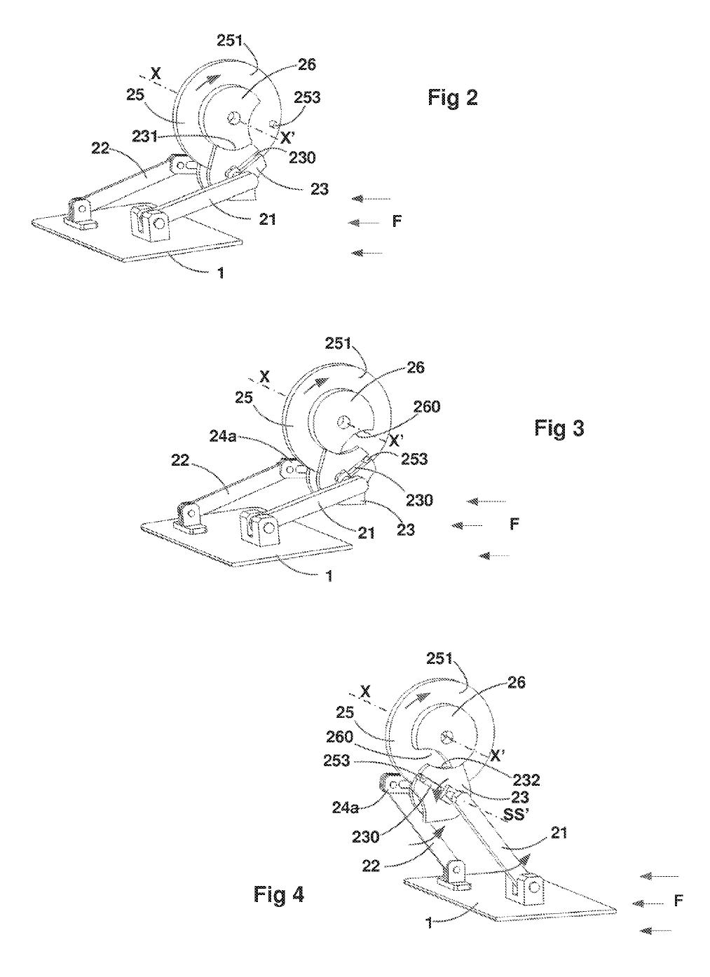

The mechanical means illustrated in FIG. 2 likewise comprises a drive wheel 25 of radius R, driven in rotation about a main rotation axis XX′ by a motor unit (not shown). The main rotation axis is parallel to the pivot axis AA′. This axis is likewise fixed in the reference frame formed by the vehicle.

The face 251 of the disk formed by the drive wheel 25 supports a pin 253 extending axially from the face 251 and arranged at a distance r₃ from the main rotation axis XX′. The first rocker 23 is arranged on the side of the face 251 supporting the pin 253. This first rocker has a slot 230 oriented radially with respect to the secondary rotation axis SS′. The first rocker 23 is arranged in such a way that, when the drive wheel is set in rotation, the pin 253 enters the slot 230 and drives the first rocker in rotation about the secondary rotation axis SS′. The first rocker then passes from one position to another. As the rotation of the drive wheel continues, the pin 253 exits the slot 230 situated on the first rocker.

The rotation of the drive wheel in the opposite direction allows the rocker to return to the previous position according to the same principles as set out above.

On the same face 251 that supports the pin 253, the drive wheel also comprises a blocking disk 26, of axis XX′, arranged in elevation with respect to the plane formed by the face 251. This blocking disk has a radius r₁ less than the distance r₃ separating the pin from the pin axis XX′.

The first rocker 23 comprises two semi-circular cutouts 231 and 232, which are of the same radius r₁ as the blocking disk 26 and are arranged on either side of the slot 230.

The first rocker 23 is thus arranged such that, when it occupies a given position, the center of one semi-circular cutout is placed on the main axis XX′. The outer edge of the semi-circular cutout then abuts against the blocking disk, which prevents the rotation of the rocker about its axis and keeps the latter in its position when the drive wheel and the blocking disk continue their rotation about the axis XX′.

The blocking disk 26 likewise has a recess 260, which is arranged in line with the pin 253 and whose size is adjusted to enable the rotation of the rocker 23 when the latter is engaged by the pin 253 and performs its rotation about the axis SS′ when changing position.

The two semi-circular cutouts 231 and 232 thus define a first and a second position occupied by the first rocker 23. These two positions are stable.

The angular difference between these two positions is defined geometrically by the distance between the main rotation axis SS′ and the main axis XX′ by the radius r₁ of the blocking disk, and by the position r₃ of the pin. This angular difference is adjusted so that the rotation of the first rocker 23 from one position to another causes the flap to pass from the retracted position, in which the flap is set back, to the deployed position.

The above indications apply mutatis mutandis to the second rocker 24 which controls the movement of the link rod 22 and the pivoting of the flap about the axis AA′.

With substantial changes to the mechanism, the rocker 24 could be situated on the same face 251 as the rocker 23. However, the second rocker 24 will preferably be arranged on the side of the face 252 of the disk formed by the wheel drive 25, and opposite the face 251. The second rocker 24 is likewise articulated about the secondary rotation axis SS′.

The radius r₂ of the blocking disk 27 (not visible in FIG. 1) arranged in elevation on the face 252, and the radial positioning r₄ of the pin 254 passing through the slot 240 (not visible in FIG. 1) of the second rocker 24 and arranged on the face 252, may or may not be identical to the radius r₁ and r₃, respectively.

The radii of the semicircular cutouts 241 and 242 (not visible in FIG. 1) will be adapted accordingly.

The respective angular positions of the pins 253 and 254 about the main axis XX′ are adjusted such that, when the drive wheel travels over an angular path of less than 360°, the change of position of the first rocker 23 takes place when the second rocker 24 is arranged in the first position, and such that the change of position of the second rocker 24 takes place when the first rocker 23 is arranged in the second position.

With these original mechanical means, it is possible, on the one hand, to comply structurally with the kinematics of the respective extending and pivoting movements as described above, and, on the other hand, to ensure that the rotation of the first rocker 23 is blocked by the blocking disk 26 before starting the pivoting of the flap about the pivot axis. Indeed, as has already been mentioned, although the torque necessary for performing this movement is theoretically negligible, the aerodynamic pressure on the flap increases considerably during the pivoting, and a substantial torque about the axis SS′ is exerted on the first rocker 23, which supports the first link rod 21.

When this first rocker 23 is in the second position, its movement is blocked by the disk 26, and it will then be found that the torque exerted by these aerodynamic forces on the axis XX′, which is the motor axis, is zero.

In order to increase the retracting speed of the flap, it is even possible to initiate the rotational movement of the first rocker 23, attached to the first link rod 21, slightly before the end of the pivoting movement of the flap, by suitably adjusting the respective angular positions of the pins 253 and 254.

The retracting movement of the flap is effected by reversing the direction of rotation of the drive wheel, which successively brings about the pivoting movement of the flap in the opposite direction, so as to place the plane of the flap in a position parallel to the direction of the air flow, and then the retracting movement of the flap.

Thus, the deployment movement and retraction movement of the flap are effected by performing a rotation of the drive wheel through less than 360°. This makes it possible in particular to retract the flap extremely quickly upon detection of an obstacle that risks damaging it.

FIGS. 2, 3 and 4 illustrate the extension movement of the flap 1.

In FIG. 2, the flap 1 is in the retracted position and its plane is substantially parallel to the air flow F circulating around the bodywork element when the vehicle is moving and on which it is fixed. The first rocker 23 is in the first position and its rotation about the axis SS″ is blocked by the engagement of the disk 26 in the semi-circular cutout 231. The second rocker is likewise in the first position, such that the plane of the flap is parallel to the air flow.

The drive wheel 251 is set in rotation, and the pin 253 enters the slot 230 of the first rocker, forcing the latter to turn about the axis SS′, as is illustrated in FIG. 3. The recess 260 frees a space allowing the first rocker 23 to pass from the first position to the second position.

The first link rod 21 turns about the axis SS′ and drives the rotation of the second link rod 22 about the axis cc′, which brings the flap 1 to the extended position, as illustrated in FIG. 4.

The second rocker 24 is maintained in its first position, and the flap 1 still remains parallel to the air flow F.

When the first rocker 23 is in the second position, the disk 26 engages the semi-circular cutout 232. The first rocker 23 and the first link rod 21 are then blocked in this second position.

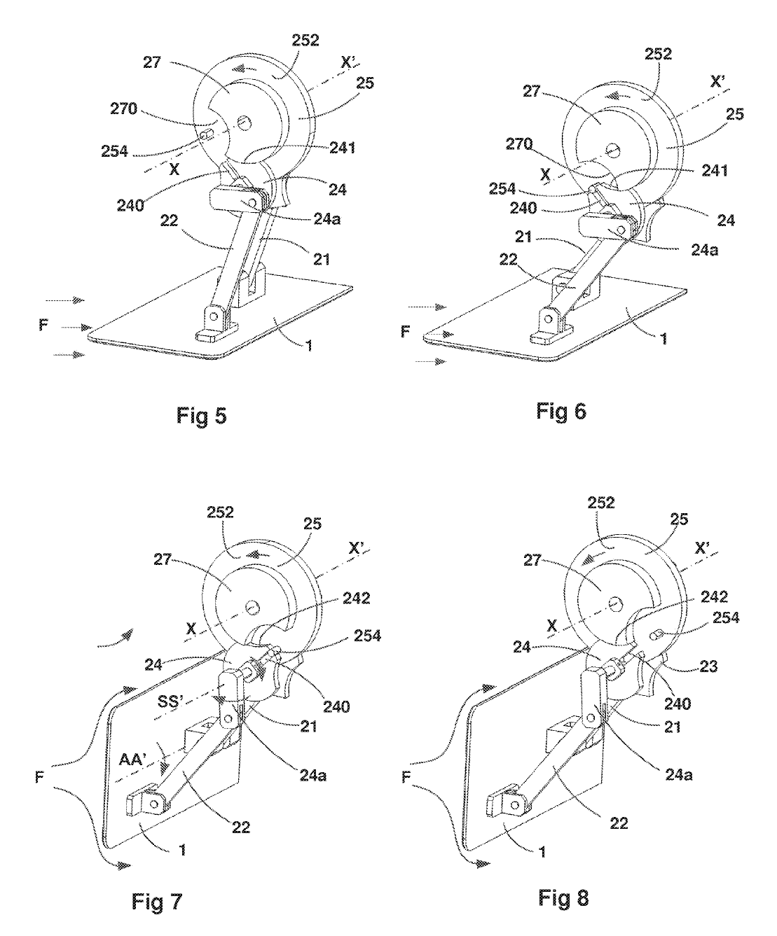

FIGS. 5, 6, 7 and 8 illustrate the kinematics of the pivoting of the flap about the pivot axis AA′.

FIG. 5 illustrates the maneuvering device seen from the direction of the face 252, in the deployed position illustrated in FIG. 4. The blocking disk 27 is engaged in the cutout 241 of the second rocker 24 and keeps the latter in the first position.

As the rotation of the drive wheel continues in the same direction as above, the pin 254 engages in the radial slot 240 of the second rocker arm 24 as shown in FIG. 6, and the recess 270 frees the space allowing the second rocker 27 to turn about the secondary rotation axis SS′.

The second rocker 24 then passes from the first position to the second position, as is illustrated in FIG. 7. The second link rod 22, whose axis of articulation on the second rocker 24 is offset by a given distance d, causes the flap 1 to turn about the pivot axis AA′.

The torque applied to the drive wheel 25 is reduced to the torque simply required to overcome friction. The friction is not insignificant, on account of the pressure exerted on the first rocker 23 by the disk 26 in order to keep it in the second position.

As its rotation continues, the disk 27 engages the semi-circular cutout 242 and blocks the second rocker 24 in the second position, as is illustrated in FIG. 8.

It will be noted here that the second link rod 22 is connected to the second rocker 24 by way of a transfer arm 24a. This transfer arm is made integral with the second rocker by a fixed connection, such that the transfer arm 24a is blocked in rotation with respect to the second rocker arm 24. This set-up has been chosen for reasons of size and in order to accommodate a bearing for supporting the shaft forming the secondary rotation axis SS′. Moreover, as has already been mentioned, the transfer arm 24a and the second rocker 24 could also form a single component.

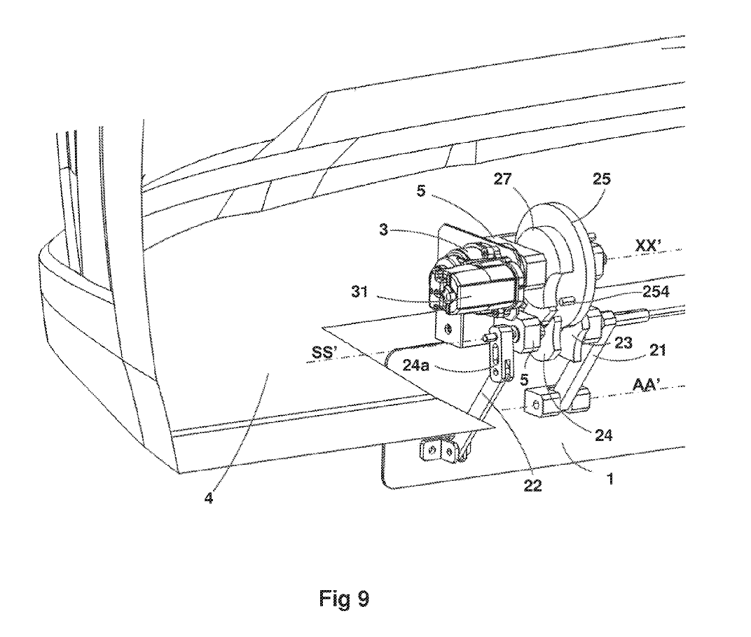

FIG. 9 illustrates the maneuvering device arranged on the lower wall of a front bumper 4 of a motor vehicle and placed in the deployed position in which the flap is extended and pivoted. The device is mounted on a bracket 5 connected to the vehicle chassis. The bracket 5 supports the shaft carrying the secondary rotation axis SS′ and the shaft carrying the main axis XX′. The latter is connected to a drive motor 3 by way of a geared motor 31 for driving the wheel 25 in rotation in one direction or another.

The maneuvering device as described above can be adapted in numerous ways when the aerodynamic flap is arranged on other parts of the vehicle.

It is thus conceivable to control the movement of each of the rockers with the aid of two independent drive wheels which are driven in rotation by two separate geared motors, while maintaining a geometric arrangement in which the axes of the articulations form a deformable parallelogram. It is then possible to provide rockers which have more than two semi-circular cutouts and which, by causing the drive wheel to turn several times about the main axis, are able to occupy a plurality of intermediate positions between each of the end positions. This arrangement may be particularly advantageous when, for example, seeking to regulate the aerodynamic pressure on the flap by acting on its angle of incidence, while minimizing the consumption of driving power for causing the flap to move from one position to another.

All of these mechanisms permit compliance with the operating principles forming the subject matter of the invention, which have the particular advantage of being low energy consumers.

### LIST OF REFERENCE SIGNS

1 aerodynamic flap
10 center of aerodynamic thrust
2 mechanical means
21 first link rod
210 first articulation of the first link rod
211 second articulation of the first link rod
22 second link rod
220 first articulation of the second link rod
221 second articulation of the second link rod
23 first rocker
230 radial slot of the first rocker
231, 232 semi-circular cutouts of the first rocker
24 second rocker
24a transfer arm connected to the rocker 24
240 radial slot of the second rocker
241, 242 semi-circular cutouts of the second rocker
25 drive wheel
251, 252 faces of the disk formed by the drive wheel
253 pin arranged on the face 251 of the drive wheel
254 pin arranged on the face 252 of the drive wheel
27 blocking disk arranged on the face 251 of the drive wheel
260 recess of the blocking disk 26
27 blocking disk arranged on the face 252 of the drive wheel
270 recess of the blocking disk 27
3 drive motor
31 geared motor
4 vehicle bumper
5 bracket
AA′ pivot axis
aa′ axis of the first articulation of the first link rod
bb′ axis of the second articulation of the first link rod
cc′ axis of the first articulation of the second link rod
dd′ axis of the second articulation of the second link rod
d distance between the axis of the first articulation of the second link rod and the secondary axis
F aerodynamic flow
P imaginary plane perpendicular to the pivot axis
R radius of the drive wheel
r₁ radius of the blocking disk 26
r₂ radius of the blocking disk 27
r₃ distance to the main axis of the pin 253
r₄ distance to the main axis of the pin 254
SS′ secondary rotation axis
XX′ main rotation axis

1. A device for maneuvering an aerodynamic flap arranged on a motor vehicle, wherein the device comprises a mechanical device for causing the flap to pass from a retracted position to a deployed position, by performing movements in a given order of:
extending the flap while keeping a plane of the flap parallel to a direction of an air flow circulating around the flap when the vehicle is moving, such that an aerodynamic pressure exerted on the flap when the vehicle is moving is substantially zero, then
pivoting the flap about a pivot axis situated in the plane of the flap and passing substantially through a center of aerodynamic thrust of the flap, such that a torque applied on the pivot axis and resulting from the aerodynamic pressure exerted on the flap when the vehicle is moving is substantially zero,
And the flap is configured to pass from a deployed position to a retracted position by performing said movements in reverse of the given order.

2. The maneuvering device as claimed in claim 1, in which the mechanical device comprises a secondary rotation axis which is parallel to the pivot axis and about which are articulated a first rocker, which is connected to the aerodynamic flap by a first link rod and of which a change of position of the first rocker brings about the extending or retracting movement of the flap, and a second rocker, which is connected to the flap by a second link rod and of which a change of position of the second rocker brings about the pivoting movement of the flap.

3. The maneuvering device as claimed in claim 2, in which the first and second link rod are attached, by first and second articulations respectively arranged at both ends of each of the link rods and whose axes are parallel to the pivot axis, to a face of the flap on the one hand and to said rockers on the other, and in which projections, on a plane perpendicular to the pivot axis, of the axes of said articulations are substantially arranged at the four corners of a deformable parallelogram.

4. The maneuvering device as claimed in claim 3, in which:
the first link rod is connected to the flap by its first articulation, whose axis is coincident with the pivot axis, and to the first rocker by its second articulation, whose axis is coincident with the secondary rotation axis, such that the first link rod pivots about the secondary rotation axis when the first rocker changes position,
the second link rod is connected to the second rocker by its second articulation arranged radially at a given distance from the secondary rotation axis, and to the flap by its first articulation arranged at the given distance from the pivot axis of the flap.

5. The maneuvering device as claimed in claim 4, in which the positions of the link rods are set up such that a plane passing through the secondary axis and through the axis of the articulation of the second link rod on the second rocker is substantially parallel to the plane of the flap.

6. The maneuvering device as claimed in claim 2, in which the mechanical device comprises a drive wheel driven in rotation about a main axis parallel to the axis pivot, at least one face of the disk formed by the drive wheel having a pin for moving the first and second rockers in rotation from one position to another and vice versa.

7. The maneuvering device as claimed in claim 6, in which each rocker comprises a radial slot in which circulates a pin for causing said rocker to pivot from one position to another about the secondary rotation axis.

8. The maneuvering device as claimed in claim 7, in which the drive wheel comprises at least one circular blocking disk which rotates about the main axis and is arranged in elevation on each of the faces of the disk formed by the drive wheel having a pin, of which the radius is less than the distance to the main axis of said pin, and placed opposite at least one rocker.

9. The maneuvering device as claimed in claim 8, in which the drive wheel comprises two blocking disks, each arranged on one of the faces of the disk formed by the drive wheel, each of these faces having a pin, and in which the rockers are arranged in line with each of the blocking disks on either side of the disk formed by the drive wheel.

10. The maneuvering device as claimed in claim 8, in which each rocker comprises two semi-circular cutouts respectively defining a first and a second position of the rocker, arranged on either side of the radial slot, each semi-circular cutout having a radius equal to the radius of the blocking disk opposite which said rocker is placed.

11. The maneuvering device as claimed in claim 10, in which, when a rocker is placed in a position, the center of a semi-circular cutout is arranged on the main axis such that said rocker is blocked in rotation by the blocking disk opposite which said rocker is placed.

12. The maneuvering device as claimed in claim 11, in which, when the first and second rocker are each placed in a given position, a torque applied to the main rotation axis and resulting from forces exerted on the flap is zero.

13. The maneuvering device as claimed in claim 8, in which each blocking disk has a recess arranged radially in line with the pin, so as to permit the pivoting of the rocker when the pin changes position.

14. The maneuvering device as claimed in claim 3, in which:
the flap is in the retracted position when the first rocker is in a first position,
the flap is in the extended position when the first rocker is in a second position.

15. The maneuvering device as claimed in claim 3, in which:
the flap is parallel to air flow circulating on a bodywork element supporting the flap when the vehicle is moving, when the second rocker is in a first position,
the flap is in the pivoted position when the second rocker is in a second position.

16. The maneuvering device as claimed in claim 14, in which, when the drive wheel travels over an angular path of less than 360°, respective arrangements of the rockers and the pins are adjusted angularly about the main axis such that the change of position of the first rocker takes place when the second rocker is arranged in the first position, and such that the change of position of the second rocker takes place when the first rocker is arranged in the second position.

17. The maneuvering device as claimed in claim 6, in which the drive wheel is rotated under the action of a motor coupled to a geared motor.

18. The maneuvering device as claimed in claim 9, in which each rocker comprises two semi-circular cutouts respectively defining a first and a second position of the rocker, arranged on either side of the radial slot, each semi-circular cutout having a radius equal to the radius of the blocking disk opposite which said rocker is placed.
